(19) United States
(12) Patent Application Publication
(10) Pub. No.: US 2017/0280051 A1
(43) Pub. Date: Sep. 28, 2017

(54) OBSERVATION APPARATUS, MEASUREMENT SYSTEM, CULTURE VESSEL AND CONTROL METHOD FOR OBSERVATION APPARATUS

(71) Applicant: OLYMPUS CORPORATION, Tokyo (JP)

(72) Inventors: Ryosuke MOCHIZUKI, Hachioji (JP); Takayuki MATSUHASHI, Hino-shi (JP)

(21) Appl. No.: 15/461,833

(22) Filed: Mar. 17, 2017

(30) Foreign Application Priority Data
Mar. 23, 2016 (JP) 2016-058420

(51) Int. Cl. H04N 5/232; G06K 7/14; H04N 5/225

(52) U.S. Cl. CPC H04N 5/23225; H04N 5/23296; H04N 5/2256; H04N 5/2252; G06K 7/1439

(57) ABSTRACT

An observation apparatus includes a casing, an imaging unit, a driving mechanism and a processor. The casing includes a transparent plate and is configured to hold a sample placed on the transparent plate. The imaging unit is provided inside the casing and generates image data by taking an image through the transparent plate. The driving mechanism is provided inside the casing and moves the imaging unit. The processor assists control of sample imaging, based on image data which the imaging unit generates by imaging a code.

### CROSS-REFERENCE TO RELATED APPLICATIONS

This application is based upon and claims the benefit of priority from prior Japanese Patent Application No. 2016-058420, filed Mar. 23, 2016, the entire contents of which are incorporated herein by reference.

### BACKGROUND OF THE INVENTION

1. Field of the Invention

The present invention relates to an observation apparatus, a measurement system, a culture vessel and a control method for an observation apparatus.

2. Description of the Related Art

In general, an apparatus wherein a culture vessel is statically placed in an incubator and images of cultured cells or the like in the culture vessel are taken, is known in the art. For example, Jpn. Pat. Appln. KOKAI Publication No. 2005-295818 discloses a technique related to an apparatus and which takes a number of images while moving a camera (imaging unit) inside an incubator so as to take images of cells existing in a wide range of a culture vessel.

### BRIEF SUMMARY OF THE INVENTION

According to one aspect of the present invention, an observation apparatus comprises: a casing including a transparent plate and configured to hold a sample placed on the transparent plate; an imaging unit provided inside the casing and configured to generate image data by taking an image through the transparent plate; a driving mechanism provided inside the casing and configured to move the imaging unit; and a processor which assists control of sample imaging, based on image data which the imaging unit generates by imaging a code on the transparent plate.

According to another aspect of the present invention, a measurement system comprises an observation apparatus which includes such configurations as described above and which further include a communication device; and a controller which is provided outside the casing and which communicates with the observation apparatus via the communication device and controls an operation of the observation apparatus.

According to still another aspect of the present invention, a culture vessel comprises a code which provides reference position-specifying information by imaging.

According to still another aspect of the present invention, a method is a control method for an observation apparatus including a casing including a transparent plate and configured to hold a sample placed on the transparent plate; an imaging unit provided inside the casing; a driving mechanism provided inside the casing and configured to move the imaging unit. The control method includes: imaging a code arranged on the transparent plate; controlling sample imaging, based on image data on the code; moving the imaging unit; and generating image data by taking an image through the transparent plate.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically illustrating an exemplary configuration of a measurement system of the first embodiment.

FIG. 2 is a block diagram schematically illustrating an exemplary configuration of a measurement system according to one embodiment.

FIG. 3 is a side view showing an exemplary configuration of a sample and its neighboring portions according to one embodiment.

FIG. 4 is a flowchart illustrating an example of observation apparatus control processing according to one embodiment.

FIG. 5 is an explanatory diagram illustrating image acquisition performed by an observation apparatus according to one embodiment.

FIG. 6 schematically illustrates an exemplary configuration of data representing measurement results obtained by a measurement system according to one embodiment.

FIG. 7 is an explanatory diagram illustrating depth synthesis performed by an observation apparatus according to one embodiment.

FIG. 8 is a flowchart illustrating an example of controller control processing according to one embodiment.

FIG. 9 is a perspective view schematically illustrating an exemplary configuration of a measurement system of the second embodiment.

### DETAILED DESCRIPTION OF THE INVENTION

### First Embodiment

The first embodiment of the present invention will now be described with reference to the accompanying drawings. The measurement system of the present embodiment is a system which takes images of cells or the like being cultured, and which makes a record of the numbers of cells or cell groups and the morphology thereof. A code representing recorded information is attached to the bottom of a sample, which is to be measured by the measurement system. The present measurement system performs various kinds of processing, using the code. Taking images is intended to mean photographing a target object or imaging thereof, and the images obtained thereby may be still images or videos.

### <Configuration of Measurement System>

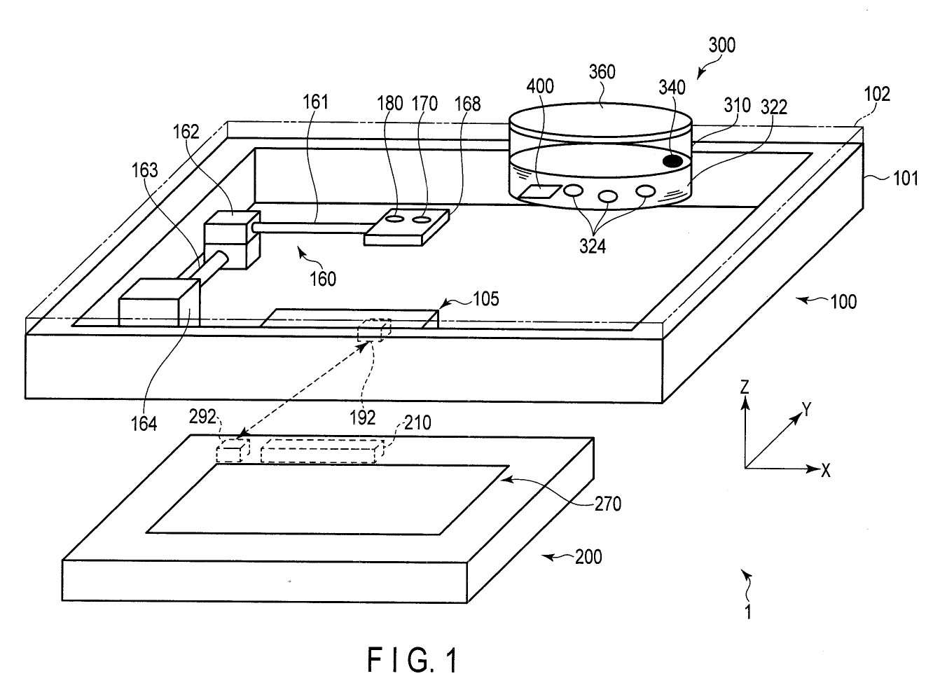

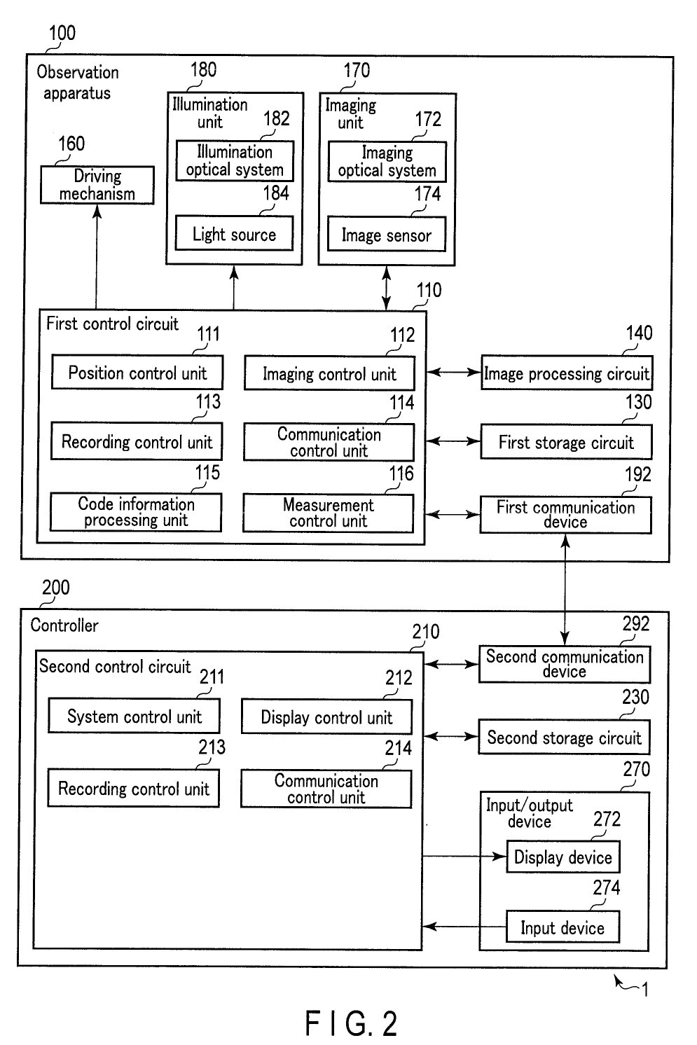

FIG. 1 is a schematic diagram schematically illustrating how the measurement system 1 looks like. FIG. 2 is a block diagram illustrating an exemplary configuration of the measurement system 1. The measurement system 1 comprises an observation apparatus 100 and a controller 200. As shown in FIG. 1, the observation apparatus 100 is substantially shaped like a plate. The observation apparatus 100 is provided, for example, inside an incubator, and a sample 300 to be observed is arranged on top of the observation apparatus 100. For the sake of explanation, an x-axis and a y-axis perpendicular to each other are defined in a plane parallel to the surface of the observation apparatus 100 on which the sample 300 is placed, and a z-axis is defined as an axis perpendicular to both the x-axis and the y-axis. A transparent plate 102 is placed on top the observation apparatus 100, and an imaging unit 170 is provided inside the observation apparatus 100. The observation apparatus 100 takes an image of the sample 300, with the transparent plate 102 interposed, and the image of the sample 300 is acquired thereby. On the other hand, the controller 200 is provided on the outside of the incubator. The observation apparatus 100 and the controller 200 communicate with each other.

### (Sample)

An example of the sample 300 to be observed by the measurement system 1 will be described. A culture medium 322 is in the vessel 310, and cells 324 are cultured in the culture medium 322. The vessel 310 is, for example, a petri dish, a culture flask, a multiwell plate, or the like. The vessel 310 is, for example, a vessel for a biological sample. The vessel 310 is, for example, a culture vessel for culturing a biological sample. The vessel 310 is not limited to any specific shape or size. The culture medium 322 may be either a liquid medium or a solid medium. The cells 324 to be measured may be either adhesive cells or floating cells. Alternatively, the cells 324 may be spheroids or tissues. In addition, the cells 324 may be derived from any living substance or may be bacteria or the like. As described above, the sample 300 includes a living sample which is either the living substance itself or is derived from the living substance.

A code 400 is attached to the bottom surface of the vessel 310. The code 400 is, for example, a two-dimensional code including black and white dots that are arranged two-dimensionally. The code 400 includes information on a reference position and information of other kinds. The observation apparatus 100 can determine a reference position in an X-Y plane of the sample 300 by photographing the code 400. The observation apparatus 100 can acquire information from the code 400 by analyzing the photographed code 400. The information included in the code 400 can be properly changed, as need arises. The information is, for example, information regarding the shape and size of the vessel 310, the depth of the culture medium 322, the cells 324, and measurement conditions.

Where the culture medium 322 is a liquid medium, a buoy 340 may float on the culture medium 322. The buoy 340 serves as a mark for confirming the upper level of the culture medium 322. A reflecting plate 360 is on top of the vessel 310. The reflecting plate 360 reflects illumination light, described later.

### (Observation Apparatus)

As shown in FIG. 1, a transparent plate 102 made of glass, for example, is on top of the casing 101 of the observation apparatus 100. The sample 300 is statically placed on this transparent plate 102. Although FIG. 1 shows that the top plate of the casing 101 is entirely transparent, the observation apparatus 100 may be designed such that part of the top plate of the casing 101 is a transparent plate, and the remaining part of the top plate is an opaque.

Various structural elements of the observation apparatus 100 are provided inside the casing 101. The interior of an incubator has, for example, a temperature of 37° C. and a humidity of 95%. Since the observation apparatus 100 is used in the conditions of high ambient temperature and humidity, the casing 101 is designed to have an air-tight structure.

A support member 168, which is inside the casing 101, is provided with an illumination unit 180 for illuminating the sample 300. The illumination unit 180 emits illumination light in the direction toward the transparent plate 102, namely, in the direction toward the sample 300. As shown in FIG. 2, the illumination unit 180 includes an illumination optical system 182 and a light source 184. The illumination light emitted from the light source 184 is made to travel to the sample 300 by the illumination optical system 182. Although the illumination unit 180 was described as being provided for the support member 168, what is required in practice is merely that the output end of the illumination optical system 182 is arranged in the support member 168. As long as this requirement is met, the light source 184 may be arranged at any position in the observation apparatus 100.

As shown in FIG. 1, an imaging unit 170 is provided in the neighborhood of the illumination unit 180 of the support member 168. The imaging unit 170 takes an image of the region where the sample 300 is present, and thus acquires an image of the sample 300. As shown in FIG. 2, the imaging unit 170 includes an imaging optical system 172 and an image sensor 174. The imaging unit 170 generates image data based on an image which is formed on the imaging plane of the image sensor 174 by the imaging optical system 172. A two-dimensional CMOS image sensor or a one-dimensional linear sensor may be employed as the image sensor 174. In addition, a light receiver having a layered structure or a plurality of light receivers of different light receiving characteristics may be employed as the image sensor 174.

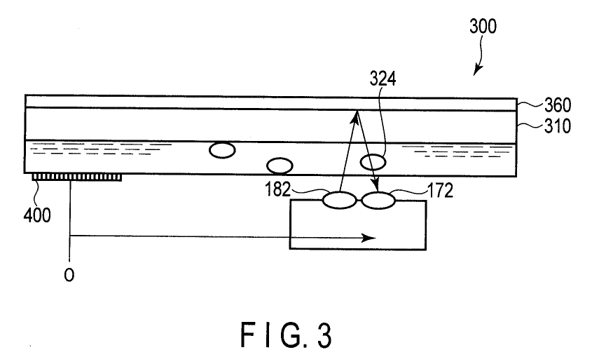

FIG. 3 is a schematic diagram illustrating a side view of the sample 300. As shown in FIG. 3, the illumination light output from the illumination optical system 182 of the illumination unit 180 falls on the reflecting plate 360 provided on top of the vessel 310, and is reflected by the reflecting plate 360. The reflected light illuminates the cells 324 and is incident on the imaging optical system 172 of the imaging unit 170. In the present embodiment, origin O, which is a reference position, is determined based on the position of the code 400. The positions photographed by the imaging unit 170 can be detected in relation to origin O. A code information processing unit, which assists imaging control, processes the code information, based on image data generated by the imaging unit 170 at the time of imaging and pertaining to the code. Imaging control, including control of the position, focus and exposure, is properly performed based on the processing results. The illumination unit 180 is controlled such that it emits illuminate light at timings that are synchronous with a vertical synchronization signal (VD) which an imaging control unit 112 uses for driving the image sensor 174.

Turning back to FIG. 1, a description will be continued. The support member 168 on which the imaging unit 170 and the illumination unit 180 are fixed is moved by a driving mechanism 160. The driving mechanism 160 is provided with an X feed screw 161 and an X actuator 162 for moving the support member 168 in the X-axis direction. The driving mechanism 160 is also provided with a Y feed screw 163 and a Y actuator 164 for moving the support member 168 in the Y-axis direction.

The imaging position in the Z-axis direction is changed by changing the focus position of the imaging optical system 172 in the direction of the optical axis. In other words, the imaging optical system 172 is provided with a focus adjustment mechanism for moving a focusing lens in the direction of the optical axis. In place of the focus adjustment mechanism or in combination therewith, the driving mechanism 160 may be provided with a Z feed screw and a Z actuator for moving the support member 168 in the Z-axis direction.

A group of circuits 105 for controlling the driving mechanism 160, imaging unit 170 and illumination unit 180 are provided inside the casing 101. A first communication device 192 is provided for the circuit group 105. The first communication device 192 is, for example, a device which communicates with the controller 200 by wireless. The communications are wireless communications using, for example, Wi-Fi or Bluetooth. The observation apparatus 100 and the controller 200 may be connected by a cable, and cable communications may be performed between them. As described above, the imaging unit 170 (which generates image data by photographing an object, with the transparent plate 102 interposed) and the driving mechanism 160 (which moves the imaging unit 170) are provided inside the casing 101. With this structure, the reliability is enhanced, easy handling and cleaning operation are ensured, and contamination can be prevented.

As shown in FIG. 2, the observation apparatus 100 comprises a first control circuit 110, a first storage circuit 130 and an image processing circuit 140, in addition to the driving mechanism 160, imaging unit 170, illumination unit 180 and first communication device 192 described above. The first control circuit 110, the first storage circuit 130, the image processing circuit 140 and the first communication device 192 are arranged, for example, in the circuit group 105 described above.

The first control circuit 110 controls each of the elements of the observation apparatus 100. The first control circuit 110 functions as a position control unit 111, an imaging control unit 112, a recording control unit 113, a communication control unit 114, a code information processing unit 115 and a measurement control unit 116. The position control unit 111 controls the driving mechanism 160 to control the position of the support member 168. The imaging control unit 112 controls the imaging unit 170 to cause the imaging unit 170 to take an image of the sample 300. The recording control unit 113 controls the recording of data obtained by the observation apparatus 100. The communication control unit 114 controls the communications with the controller 200 performed using the first communication device 192. Based on the code 400, the code information processing unit 115 determines a reference position in the X-Y plane and acquires information recoded in the code 400. The measurement control unit 116 controls the overall measurement, including measurement timings and the number of times the measurement is performed.

The first storage circuit 130 stores, for example, programs and various parameters used by the first control circuit 110. The first storage circuit 130 also stores data obtained by the observation apparatus 100.

The image processing circuit 140 performs various kinds of image processing for the image data obtained by the imaging unit 170. After the image processing by the image processing circuit 140, data are recorded in the first storage circuit 130 or transmitted to the controller 200 by way of the first communication device 192. The first control circuit 110 or the image processing circuit 140 may perform various kinds of analysis, based on the obtained image. For example, the first control circuit 110 or the image processing circuit 140 extracts an image of the cell or cell group included in the sample 300 or counts the number of cells or cell groups, based on the obtained image. The results of this analysis are recorded in the first storage circuit 130 or transmitted to the controller 200 by way of the first communication device 192.

### (Controller)

The controller 200 is, for example, a personal computer (PC) or an information terminal such as a tablet type terminal. In FIG. 1, a tablet type information terminal is depicted.

The controller 200 is provided with an input/output device 270 including a display device 272 (e.g., a liquid crystal display) and an input device 274 (e.g., a touch panel). The input device 274 is not limited to the touch panel but may include a switch, a dial, a keyboard, a mouse, etc.

A second communication device 292 is provided for the controller 200. The second communication device 292 is a device which communicates with the first communication device 192. The observation apparatus 100 and the controller 200 communicate with each other through the first communication device 192 and the second communication device 292.

The controller 200 comprises a second control circuit 210 and a second storage circuit 230. The second control circuit 210 controls each of the elements of the controller 200. The second storage circuit 230 stores, for example, programs and various parameters used by the second control circuit 210. The second storage circuit 230 also stores data obtained by the observation apparatus 100 and received from the observation apparatus 100.

The second control circuit 210 functions as a system control unit 211, a display control unit 212, a recording control unit 213 and a communication control unit 214. The system control unit 211 performs various operations for controlling the measurement of the sample 300. The display control unit 212 controls the display device 272. The display control unit 212 causes the display device 272 to display the necessary information. The recording control unit 213 controls the operation of recording information in the second storage circuit 230. The communication control unit 214 controls the communications with the observation apparatus 100 performed using the second communication device 292.

Each of the first control circuit 110, image processing circuit 140 and second control circuit 210 incorporates an integrated circuit such as a central processing unit (CPU), an application specific integrated circuit (ASIC), a field programmable gate array (FPGA), or the like. Each of the first control circuit 110, image processing circuit 140 and second control circuit 210 may be constituted by a single integrated circuit or by a combination of a number of integrated circuits. The first control circuit 110 and the image processing circuit 140 may be made by a single integrated circuit. Each of the position control unit 111, imaging control unit 112, recording control unit 113, communication control unit 114, code information processing unit 115 and measurement control unit 116 of the first control circuit 110 may be constituted by a single integrated circuit or by a combination of a number of integrated circuits. Two or more of the position control unit 111, imaging control unit 112, recording control unit 113, communication control unit 114, code information processing unit 115 and measurement control unit 116 may be constituted by a single integrated circuit or the like. Likewise, each of the system control unit 211, display control unit 212, recording control unit 213 and communication control unit 214 of the second control circuit 210 may be constituted by a single integrated circuit or by a combination of a number of integrated circuits. Two or more of the system control unit 211, display control unit 212, recording control unit 213 and communication control unit 214 may be constituted by a single integrated circuit or the like. The operations of these integrated circuits are executed, for example, in accordance with programs stored in the first storage circuit 130 or second storage circuit 230, or in accordance with the programs stored in the storage regions of the integrated circuits.

### (Operations of Measurement System)

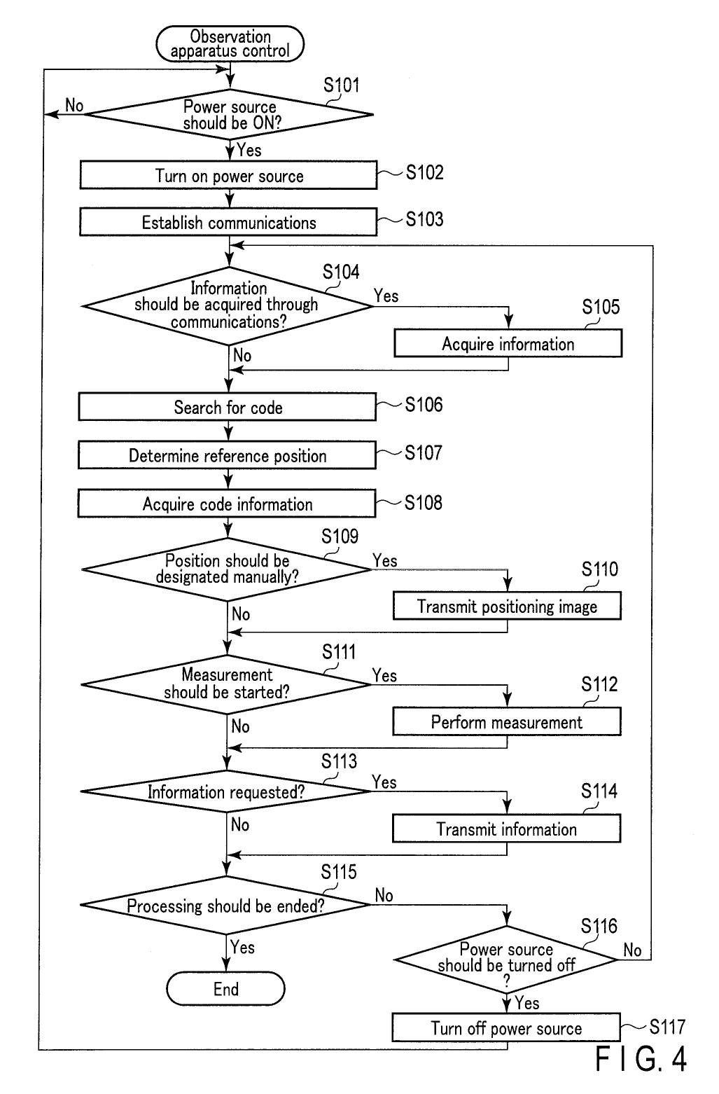

The operation of the measurement system 1 will be described. First, the operation of the observation apparatus 100 will be described with reference to the flowchart shown in FIG. 4. The flowchart of FIG. 4 starts when the observation apparatus 100, controller 200 and sample 300 are set in place.

In step S101, the first control circuit 110 determines whether or not the power source should be turned on. Where the power source is configured to be switched on at predetermined times and the time to switch on the power switch comes, the first control circuit 110 determines that the power source should be turned on. Where the observation apparatus 100 constantly communicates with the controller 200 through low-power-consumption communication means such as Bluetooth Low Energy, and when the observation apparatus 100 receives an instruction to turn on the power source from the controller 200 through the communication means, the first control circuit 110 determines that the power source should be turned on. Unless the power source is turned on, the processing stands by, repeating steps S101. If it is determined that the power source should be turned on, the processing advances to step S102.

In step S102, the first control circuit 110 turns on the power source to supply power to the respective portions of the observation apparatus 100. If the power source is turned on only when the sample 300 is measured in practice, power saving can be attained, and the driving time of the observation apparatus 100 operating on a battery can be lengthened.

In step S103, the first control circuit 110 establishes communications with the controller 200. The communication means used in the embodiment is high-speed communication means, such as Wi-Fi.

In step S104, the first control circuit 110 determines whether or not information should be acquired from the controller 200 through the established communications. For example, when information is transmitted from the controller 200, it is determined that the information should be acquired. Unless the information should be acquired, the processing advances to step S106. If the information should be acquired, the processing advances to step S105.

In step S105, the first control circuit 110 acquires the information transmitted from the controller 200. The acquired information may include condition information, such as measurement conditions (including imaging conditions, imaging intervals and other parameters), a method for recording measurements, a transmission condition for the measurements, etc. Subsequently, the processing advances to step S106.

In step S106, the first control circuit 110 searches for a code 400. For example, the imaging unit 170 takes images of the surface of the transparent plate 102, while being moved by the driving mechanism 160. The first control circuit 110 analyzes the resultant images to find the code 400.

At the time, the illumination light is emitted at timings synchronous with a vertical synchronization signal (VD) of the image sensor 174, and the emission of the illumination light is continued until the next VD is generated, namely, during the period in which the imaging corresponding to one imaging action is completed. What is required of this light emission control is merely that the code 400 is imaged. That is, the light emission may be continued for a period corresponding to less than one frame or more than one frame. The necessary information can be acquired before an observation image is taken by performing the illumination and imaging for code search before taking the observation image. By controlling the illumination in synchronism with the imaging, damage to cells which may be caused by the illumination light can be suppressed.

In step S107, the first control circuit 110 determines a reference position based on the position of the code 400. The reference position determined then may be either a point on the code 400 or a point outside the code 400 determined with the point on the code 400 being used as a reference. The reference position, thus determined, is used as the origin O of a coordinate system.

In step S108, the first control circuit 110 acquires information included in the code 400. This information can include a depth of the culture medium 322 of the sample 300. Where the depth of the culture medium 322 is known, the imaging control unit 112 adjusts the focus position of the imaging unit 170 by using information on the depth of the culture medium 322, i.e., the information on the thickness of a target object to be observed. The information obtained then can include the condition information mentioned above. Where the condition information is obtained, the first control circuit 110 performs the following processing based on the obtained condition information. If the condition information obtained from the code 400 and the condition information acquired in step S105 are different, either of the two may have priority over the other. For example, the condition information based on the code 400 may be predetermined as having priority, the condition information acquired through communications may be predetermined as having priority, or the condition information acquired later may be predetermined as having priority. Alternatively, the user may determine which condition information should be used each time.

In step S109, the first control circuit 110 determines whether or not manual position designation is performed. To be specific, it is determined whether an imaging instruction is received, with the imaging position designated by the controller 200. For example, in the second and subsequent imaging, the user can designate a position based on the image of the entire sample 300 obtained by the first-time imaging. Unless an imaging instruction is received, the processing advances to step S111. If an imaging instruction is received, the processing advances to step S110.

In step S110, the first control circuit 110 causes the driving mechanism 160 to move the imaging unit 170 to a designated position and causes the imaging unit 170 to acquire an image at that position. The first control circuit 110 transmits the obtained images to the controller 200 by way of the first communication device 192. Subsequently, the processing advances to step S111.

In step S111, the first control circuit 110 determines whether or not the current time is a time when the measurement should be started. Unless the current time is a measurement start time, the processing advances to step S113. If the current time is a measurement start time, the processing advances to step S112. The measurement start time may be predetermined, for example, at the intervals of one hour. Information on the measurement start time may be recorded in the code 400. The measurement start condition need not be dependent on time; it may be determined in accordance with the state of cells 324 or culture medium 322. In the present embodiment, measurement is repeatedly performed whenever the measurement start time comes.

In step S112, the first control circuit 110 performs measurement processing. In other words, the first control circuit 110 causes the imaging unit 170 to repeatedly take an image, while simultaneously causing the driving mechanism 160 to move the imaging unit 170. The first control circuit 110 performs predetermined processing for an image taken by the imaging unit 170 and records a requested result in the first storage circuit 130. Subsequently, the processing advances to step S113.

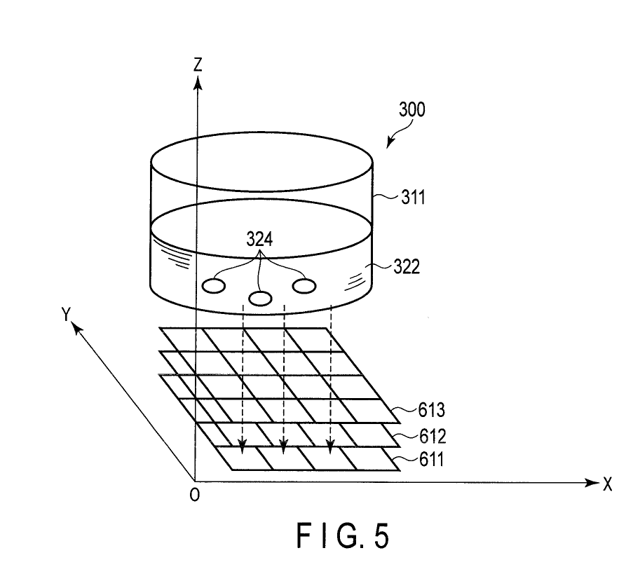

The image acquisition performed in measurement processing will be described, referring to the schematic diagram shown in FIG. 5. The observation apparatus 100 repeatedly takes an image, while changing its position in the X direction and Y direction in the first plane, for example, and a plurality of images are acquired thereby. The image processing circuit 140 synthesizes these images, thereby preparing one first image 611 of the first plane. The first plane is a plane perpendicular to the optical axis of the imaging unit 170, i.e., a plane parallel to the transparent plate 102. Further, the observation apparatus 100 changes the imaging position in the thickness direction to a second plane and to a third plane, and repeatedly takes an image, while changing its position in the X direction and Y direction in each of the planes. A second image 612 and a third image 613 are acquired from the images. The thickness direction is a Z-axis direction, the optical axis direction of the imaging unit 170, and is perpendicular to the transparent plate 102. In this manner, an image at each three-dimensional position is acquired. In the above, a description was given of an example in which an image is repeatedly taken, with the imaging plane being changed in the Z direction. Instead of this, an image may be repeatedly taken, with the imaging plane being changed only in the X direction and Y direction (not in the Z direction). In this case, a synthesis image of one plane is obtained.

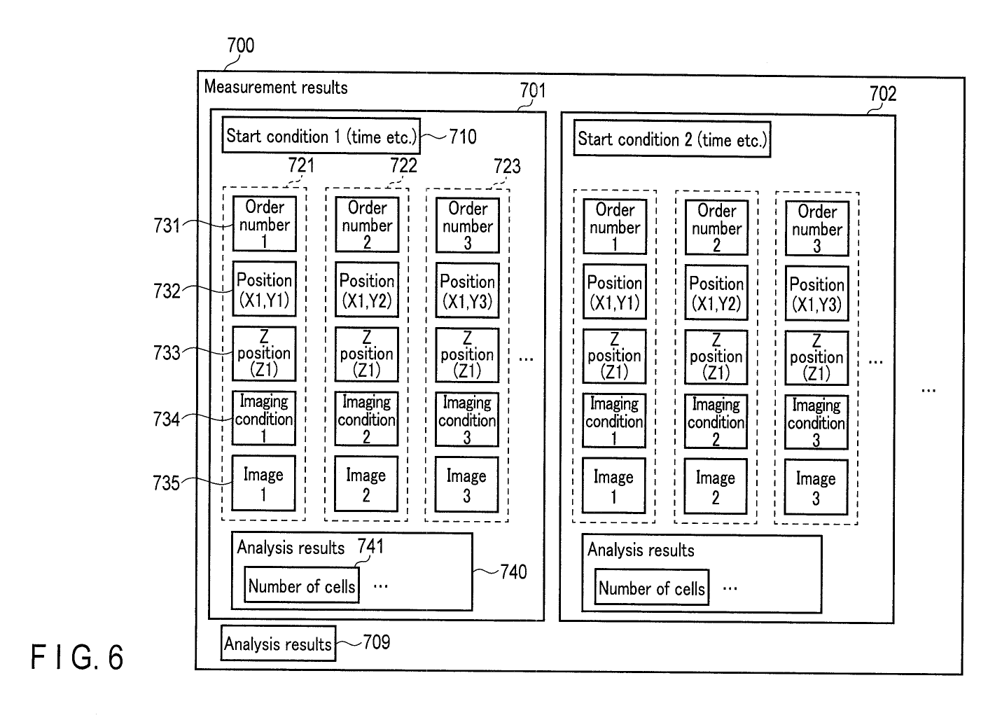

An example of a data structure of measurement results obtained as above and recorded in the first storage circuit 130 is shown in FIG. 6. As shown in FIG. 6, the measurement results 700 include first data 701 obtained by first-time measurement, second data 702 obtained by second-time measurement, etc. The number of data increases or decreases in accordance with the number of times measurement is performed.

The first data 701 will be described by way of example. The first data 701 includes a start condition 710. This start condition 710 includes a condition under which the measurement start is determined in step S111. For example, a measurement start time is predetermined, and when measurement is started at this measurement start time, the measurement start time is recorded as a start condition 710.

In the first data 701, first image information 721, second image information 722, third image information 723, etc. are recorded. Each of these data is a set of data acquired in one-time imaging. The first image information 721 will be described by way of example. The first image information 721 includes an order 731, a position 732, a Z position 733, an imaging condition 734, and an image 735. The order 731 is indicated by serial numbers which are assigned to the image operations performed for respective positions. The position 732 includes an X coordinate and a Y coordinate of an imaging position. The X coordinate and the Y coordinate are, for example, coordinates that are obtained, with the origin O based on code 400 being used as a reference. The X coordinate and the Y coordinate are values used for the control of the driving mechanism 160 and are acquired by the position control unit 111, for example. The Z position 733 includes a Z coordinate of an imaging position. The Z coordinate is a value used for the control of the imaging optical system 172 and is acquired by the imaging control unit 112, for example. The imaging condition 734 includes exposure conditions, such as a shutter speed and an aperture value, and other imaging conditions. The imaging conditions may differ, depending upon each imaging operation. They may be the same for the imaging operations included in the first data 701. Alternatively, they may be the same for all imaging operations included in the measurement results 700. The image 735 is image data obtained by the imaging. Likewise, each of the second image information 722 and the third image information 723 includes information regarding an order, a position, a Z position, an imaging condition and an image. Where an imaging plane is not moved in the Z direction, the information on the Z position may be omitted.

The first data 701 includes analysis results 740. The analysis results 740 include a cell number 741 representing the number of cells or cell groups measured by the image processing circuit 140. The analysis results 740 also include a plane image obtained by synthesizing the images of the same Z position. The analysis results 740 also include a three-dimensional image obtained by synthesizing all images 735. The analysis results 740 may include a depth-synthesis image.

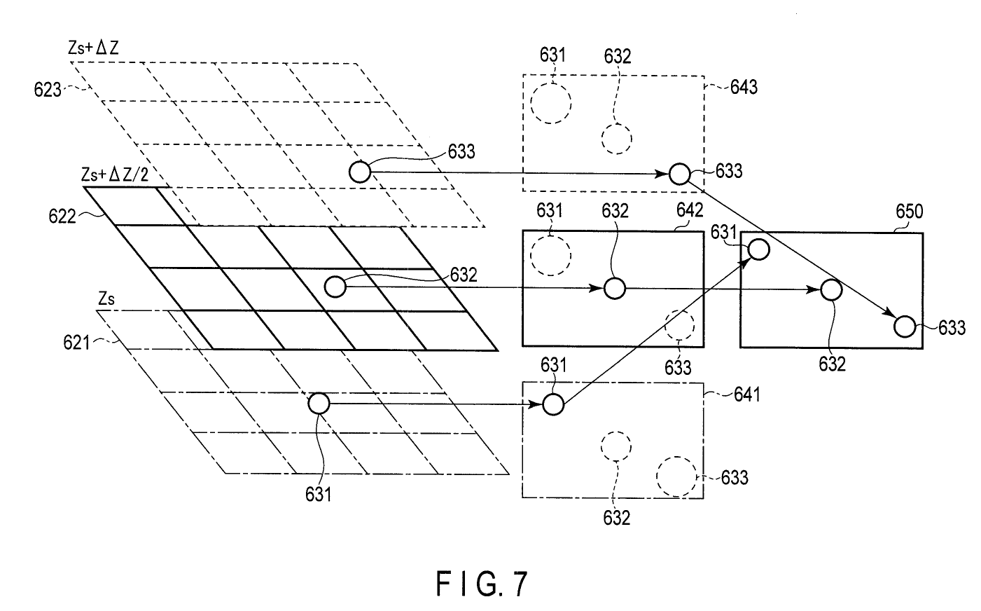

The depth-synthesis image will be described with reference to FIG. 7. Consideration will be given to the case where a first cell 631 is present in the first plane 621 whose Z coordinate is Zs, a second cell 632 is present in the second plane 622 whose Z coordinate is Zs+ΔZ/2, and a third cell 633 is present in the third plane 623 whose Z coordinate is Zs+ΔZ. Let us assume that that the imaging performed with the focus position being changed creates a first image 641 in which the first plane 621 is in focus, a second image 642 in which the second plane 622 is in focus, and a third image 643 in which the third plane 623 is in focus. In the first image 641, the first cell 631 is in focus, and the other cells are not. Likewise, in the second image 642, the second cell 632 is in focus, and the other cells are not. In the third image 643, the third cell 633 is in focus, and the other cells are not. In the depth-synthesis image 650, the image of the first cell 631 included in the first image 641, the image of the second cell 632 included in the second image 642, and the image of the third cell 633 included in the third image 643, are synthesized with one another. As a result, in the resultant depth-synthesis image 650, the first cell 631, the second cell 632 and the third cell 633 are all in focus. Such a depth-synthesis image may be included in the analysis results 740.

As described above, the code 400 can include position information, focus information and other kinds of auxiliary information, which cannot be obtained by the imaging of a sample such as cells. The use of such auxiliary information enables prompt and accurate imaging to be performed in accordance with the circumstances. The auxiliary information may be exposure information. In this case, the aperture value, the exposure time, the standby time, the intensity of illumination light, etc. can be properly controlled in accordance with the circumstances.

Like the first data 701, the second data 702 includes a start condition, first image data, second image data, third image data, analysis results, etc.

The measurement results 700 can include analysis results 709 of the overall measurement that are obtained based on the first data, second data, etc. All measurement results 700 may be recorded in one file; alternatively, part of the measurement results 700 may be recorded in one file.

Turning back to FIG. 4, a description will be continued. In step S113, the first control circuit 110 determines whether or not a request for information is made by the controller 200. For example, the data obtained in step S112 is requested by the controller 200. Unless the request for information is made, the processing advances to step S115. If the request for information is made, the processing advances to step S114.

In step S114, the first control circuit 110 transmits the information requested by the controller 200 to the controller 200 through the first communication device 192. Subsequently, the processing advances to step S115.

In step S115, the first control circuit 110 determines whether or not the observation apparatus control processing should be ended. If it is determined that the observation apparatus control processing should be ended, the observation apparatus control processing is brought to an end. For example, when a series of measurements have ended, and the observation apparatus 100 is removed from the incubator, the observation apparatus control processing is brought to an end. Unless the observation apparatus control processing is brought to an end, the processing advances to step S116.

In step S116, the first control circuit 110 determines whether or not the power source should be turned off. For example, if the standby time from the measurement in step S112 to the next measurement is long, the first control circuit 110 determines that the power source should be turned off to suppress the power consumption. Unless the power source is turned off, the processing returns to step S104. If it is determined that the power source should be turned off, the processing advances to step S117.

In step S117, the first control circuit 110 turns off each portion of the observation apparatus 100. Subsequently, the processing returns to step S101. In the above manner, the observation apparatus 100 repeatedly performs measurement.

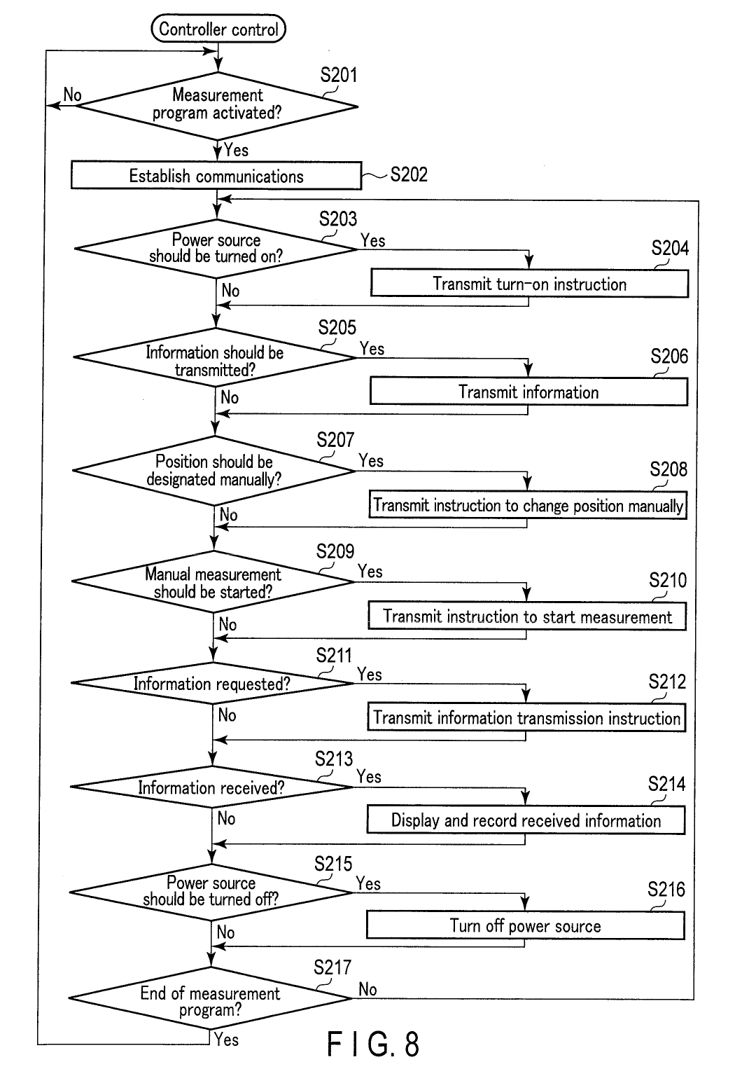

Next, the operation of the controller 200 will be described with reference to the flowchart shown in FIG. 8. The processing shown in the flowchart of FIG. 8 starts when the observation apparatus 100, controller 200 and sample 300 are set in place.

In step S201, the second control circuit 210 determines whether or not a measurement program according to the present embodiment is activated. Unless the measurement program is activated, the processing of step S201 is repeated. The controller 200 is not limited to the functions of the controller of the measurement system of the present embodiment but may have various functions. Therefore, when the measurement program is not activated, the controller 200 may operate as a system other than the measurement system 1. If it is determined that the measurement program is activated, the processing advances to step S202.

In step S202, the second control circuit 210 establishes communications with the observation apparatus 100. This operation is related to step S103 of the observation apparatus control performed by the observation apparatus 100. That is, the observation apparatus 100 and the controller 200 operate such that the communications between them are established. The communications established then may be low-power-consumption communications being irrelevant to step S103 of the observation apparatus control and only enabling the transmission of an instruction to turn on the observation apparatus 100.

In step S203, the second control circuit 210 determines whether or not the user is requesting that the observation apparatus 100 be turned on. For example, if an instruction to turn on the observation apparatus 100 is supplied from the input device 274, the second control circuit 210 determines that the user is requesting that the power source be turned on. Unless the instruction to turn on the observation apparatus 100 is supplied, the processing advances to step S205. If the instruction to turn on the observation apparatus 100 is supplied, the processing advances to step S204. In step S204, the second control circuit 210 transmits an instruction to turn on the observation apparatus 100 to the observation apparatus 100. Subsequently, the processing advances to step S205. This operation is related to step S101 of the observation apparatus control performed by the observation apparatus 100. Upon receipt of the instruction to turn on the observation apparatus 100 from the controller 200, the observation apparatus 100 is turned on in step S102. The communication means used in the embodiment are low-power-consumption communications such as Bluetooth Low Energy.

In step S205, the second control circuit 210 determines whether or not the user is requesting the transmission of information to the observation apparatus 100. For example, if an instruction to transmit information is supplied from the input device 274, the second control circuit 210 determines that the user is requesting the transmission of information. The information the transmission of which is requested is information on measurement conditions etc. Unless the transmission of information is requested, the processing advances to step S207. If the transmission of information is requested, the processing advances to step S206. In step S206, the second control circuit 210 transmits the information entered from the input device 274 to the observation apparatus 100. Subsequently, the processing advances to step S207. This operation is related to step S104 of the observation apparatus control performed by the observation apparatus 100. The observation apparatus 100 acquires the information transmitted from the controller 200 to the observation apparatus 100 in step S105.

In step S207, the second control circuit 210 determines whether or not the user manually designates a position to be imaged by the observation apparatus 100. For example, if an imaging position is entered from the input device 274, the second control circuit 210 determines that imaging position has been designated. Unless the imaging position is designated, the processing advances to step S209. If the imaging position is designated, the processing advances to step S208. In step S208, the second control circuit 210 transmits the imaging position entered from the input device 274 to the observation apparatus 100. Subsequently, the processing advances to step S209. This operation is related to step S109 of the observation apparatus control performed by the observation apparatus 100. Position adjustment is made in step S110 in accordance with the imaging position transmitted from the controller 200 to the observation apparatus 100. An image is acquired at that position and transmitted.

In step S209, the second control circuit 210 determines whether or not the user is requesting that the observation apparatus 100 start measurement. For example, if an instruction to start measurement by the observation apparatus 100 is supplied from the input device 274, the second control circuit 210 determines that the user is requesting start of measurement. If the start of measurement is not requested, the processing advances to step S211. If the start of measurement is requested, the processing advances to step S210. In step S210, the second control circuit 210 transmits an instruction to start measurement to the observation apparatus 100. Subsequently, the processing advances to step S211. This operation is related to step S111 of the observation apparatus control performed by the observation apparatus 100. Measurement is performed in step S112 in accordance with the instruction transmitted from the controller 200 to the observation apparatus 100.

In step S211, the second control circuit 210 determines whether or not the user is requesting acquiring information from the observation apparatus 100. For example, if an instruction to request information is supplied from the input device 274, the second control circuit 210 determines that the user is requesting information. The information requested then is, for example, information on the sample 300 obtained by the observation apparatus 100. The information can be information included in the measurement results 700 described with reference to FIG. 6, and includes, for example, image data on the sample 300, the number of cells or cell groups included in the sample 300, etc. Unless the information is requested, the processing advances to step S213. If the information is requested, the processing advances to step S212. In step S212, the second control circuit 210 transmits an instruction to transmit the user's requested information to the observation apparatus 100. Subsequently, the processing advances to step S213. This operation is related to step S113 of the observation apparatus control performed by the observation apparatus 100. The information requested in step S114 is transmitted from the observation apparatus 100 to the controller 200 in accordance with the information request transmitted from the controller 200 to the observation apparatus 100.

In step S213, the second control circuit 210 determines whether or not the information requested in step S212 is received. Unless the information is received, the processing advances to step S215. If the information is received, the processing advances to step S214. In step S214, the second control circuit 210 displays the received information on the display device 272 or records it in the second storage circuit 230. Subsequently, the processing advances to step S215.

In step S215, the second control circuit 210 determines whether or not the user is requesting that the observation apparatus 100 be turned off. For example, if an instruction to turn off the observation apparatus 100 is supplied from the input device 274, the second control circuit 210 determines that the user is requesting that the power source be turned off. Unless the instruction to turn off the observation apparatus 100 is supplied, the processing advances to step S217. If the instruction to turn off the observation apparatus 100 is supplied, the processing advances to step S216. In step S216, the second control circuit 210 transmits an instruction to turn off the observation apparatus 100 to the observation apparatus 100. Subsequently, the processing advances to step S217. This operation is related to step S116 of the observation apparatus control performed by the observation apparatus 100. The observation apparatus 100 is turned off in step S117 in accordance with the turn-off instruction transmitted from the controller 200 to the observation apparatus 100.

In step S217, the second control circuit 210 determines whether or not the measurement program comes to an end. If the measurement program ends, the processing returns to step S201. Unless the measurement program ends, the processing returns to step S203. As can be seen from this, the above operation is repeatedly executed.

As described above, the measurement by the measurement system 1 is repeatedly performed at predetermined timings and under predetermined conditions. Measurement timings and measurement conditions may be entered by the user from the controller 200 and set in the observation apparatus 100. Information regarding the measurement timings and measurement conditions may be included in the code 400. In this case, the measurement timings and measurement conditions are set in the observation apparatus 100 when the observation apparatus 100 acquires the information from the code 400. The measurement by the measurement system 1 may be manually performed based on the user's instruction when the user's instruction is entered from the controller 200 and supplied to the observation apparatus 100.

### <Advantage of the Measurement System>

The measurement system 1 of the present embodiment can take an image of cells in a wide range in the state where the sample 300 is kept stationary in the incubator. It should be noted that an image can be repeatedly taken with time. Since a reference position, such as the origin of coordinates, is determined based on the code 400 each time an image is taken, images taken at different times can be compared with one another, with attention focused on the same portion. As a result, how the same cell or cell group changes with time can be observed by comparing the images. Even if the sample 300 is shifted in position as a result of the replacement of a culture medium, the code 400 of the sample 300 remains at the same position. In the case of adhesive cells, how the same cell or cell group changes with time can be observed by comparison of images. The user can therefore observe how the cell or cells change with time and analyze the change. When a reference position is specified, the information included in the code 400 is acquired based on an image of the code 400. Therefore, the reference position can be specified only by the imaging unit 170 of the observation apparatus 100, and a unit other than the imaging unit 170 is not required for acquiring the information. Accordingly, the observation apparatus 100 can be simple. It should be noted that the code 400 can include various kinds of information. Therefore, where measurement conditions are included in the code 400 by the user, the observation apparatus 100 can perform measurement in accordance with the conditions. The user does not have to perform complicated operations for the measurement.

### <Modifications>

Although the code 400 mentioned in connection with the above embodiment is a two-dimensional code, it may be a bar code or the like. In connection with the above embodiment, reference was made to the case where an image of the code 400 is taken and the origin and condition information are acquired from the image. However, this is not restrictive. A magnetic chip or an IC chip may be used in place of the code 400, and information included therein may be read.

The information included in the code 400 is information that cannot be easily obtained by the imaging of a sample such as cells. That is, the information supplements the position and focus information, and thus enables prompt and accurate imaging to be performed in accordance with the circumstances. The supplemental information may be exposure information. In this case, the aperture value, the exposure time, the standby time, the intensity of illumination light, etc. can be properly controlled in accordance with the circumstances. Not only the intensity of illumination light but also the wavelength and illumination time may be controlled. Furthermore, the ID of a researcher, the time of imaging, the number of times imaging is performed, the name of a sample, etc. may be included in the supplemental information.

In connection with the above embodiment, reference was made to the case where the observation apparatus 100 processes the images obtained by the imaging unit 170, analyses the information included in the code 400, and analyses measurement results. However, this is not restrictive. The second control circuit 210 of the controller 200 may perform at least one of these processes if unprocessed data is transmitted from the observation apparatus 100 to the controller 200.

In the above-mentioned embodiment, reference was made to the case where the transparent plate 102 covers the upper region of the casing 101 of the observation apparatus 100, and the sample 300 is placed on top of the casing 101. However, this is not restrictive. The shape of the observation apparatus 100 may be properly modified in accordance with the shape of the sample 300, the observation direction, or the like.

### Second Embodiment

The second embodiment of the present invention will be described. In the description below, reference will be made to how the second embodiment differs from the first embodiment. Therefore, the same symbols will be used to denote structural elements similar or corresponding to those of the first embodiment, and a description of such structural elements will be omitted. In the measurement system 1 of the first embodiment, the code 400 is provided on the bottom of the sample 300. In the second embodiment, a code is provided on a fixing frame.

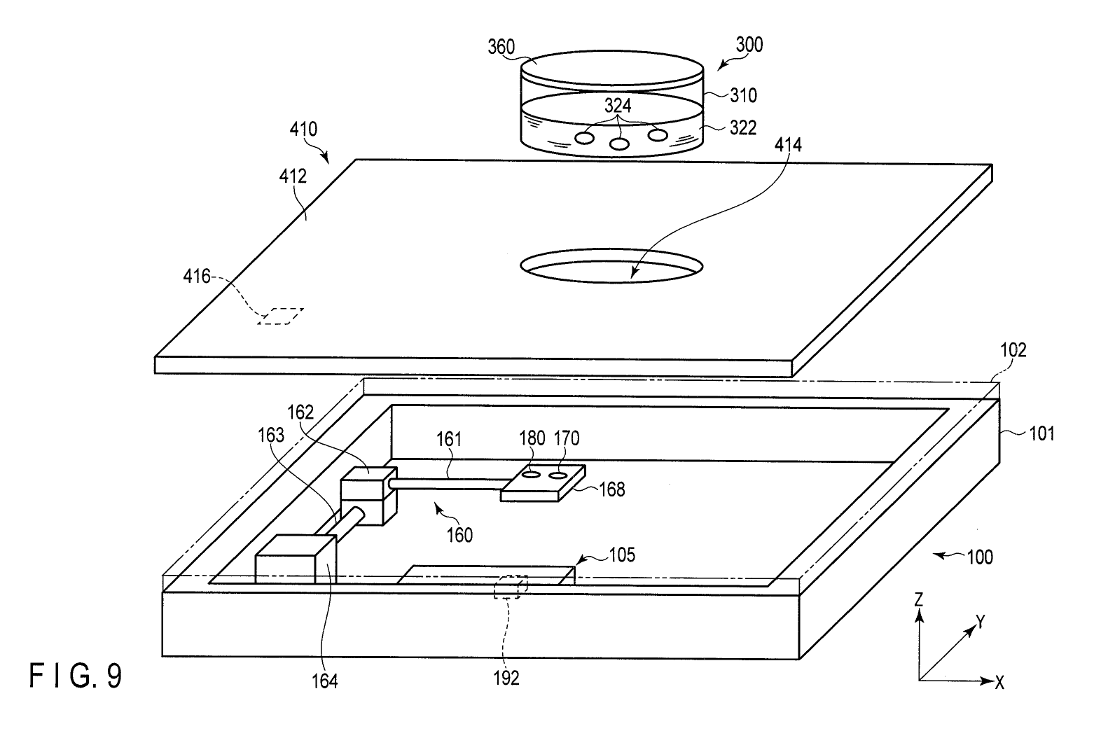

FIG. 9 schematically illustrates the measurement system 1 according to the second embodiment. As shown in FIG. 9, in the second embodiment, a fixing frame 410 is placed on a transparent plate 102. The fixing frame 410 is designed such that it is arranged at a specific position with respect to the transparent plate 102. For example, the fixing frame 410 may have the same size as the transparent plate 102. The fixing frame 410 includes a fixing plate 412 and a hole 414 formed in the fixing plate 412. The hole 414 has a diameter slightly larger than the outer diameter of the vessel 310 of the sample 300. In the state where the fixing frame 410 is placed on the transparent plate 102, the vessel 310 can be fixed in the hole 414.

A code 416 is provided on that surface of the fixing frame 410 which faces the transparent plate 102. The code 416 is, for example, a two-dimensional code. The code 416 includes information representing the position of the hole 414 relative to the reference position of the code 416. The code 416 can include information regarding the shape and size of the vessel 310. In other words, the code 416 can include information regarding a region in a plane parallel to the transparent plate 102. The code 416 can include information regarding the depth of the culture medium 322, the cells 324, measurement conditions, etc.

The observation apparatus 100 takes an image of the code 416 and analyzes the image to acquire various kinds of information, including the position of the sample 300. The information includes region information indicating where in a plane parallel to the transparent plate 102 the sample 300 is arranged. Therefore, the observation apparatus 100 can control an observation operation based on the obtained information.

The same advantages as described above in relation to the measurement system 1 of the first embodiment can be obtained by the measurement system 1 of the second embodiment as well. In addition, in the second embodiment, the position of the sample 300 is fixed by the fixing frame 410. Therefore, if the position of the code 416 is predetermined on the fixing frame 410, the observation apparatus 100 can take an image of the code 416 without the need to search for the code 416. As a result, the observation apparatus 100 can locate the position of the sample 300 without searching for it.

Of the techniques described in connection with the above embodiments, the controls described with reference to flowcharts are realized as programs. The programs can be stored in a recording medium or a storage unit. The programs can be recorded in the recording medium or storage unit in various ways. They may be recorded at the time of shipping a product, they can be recorded using a distributed recording medium, or they can be downloaded from the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An observation apparatus comprising:
a casing including a transparent plate and configured to hold a sample placed on the transparent plate;
an imaging unit provided inside the casing and configured to generate image data by taking an image through the transparent plate;
a driving mechanism provided inside the casing and configured to move the imaging unit; and
a processor which assists control of sample imaging, based on image data which the imaging unit generates by imaging a code on the transparent plate.

2. The observation apparatus according to claim 1, wherein the processor
determines a reference position where the imaging unit is located in a plane parallel to the transparent plate based on the image data on the code, and
controls a position of the imaging unit moved by the driving mechanism by use of the reference position.

3. The observation apparatus according to claim 1, wherein
the code includes thickness information representing length of the sample as determined in a direction perpendicular to the transparent plate,
the processor acquires the thickness information, based on the image data on the code, and
the imaging unit adjusts a focus position by utilizing the thickness information.

4. The observation apparatus according to claim 1, wherein
the code includes region information indicative of a region which is related to the sample and defined in a plane parallel to the transparent plate, and
the processor acquires the region information, based on the image data on the code, and controls a position of the imaging unit by use of the region information.

5. The observation apparatus according to claim 1, wherein
the processor controls measurement timings or a number of times the imaging unit performs imaging,
the code includes condition information regarding measurement conditions,
the processor acquires the condition information, based on the image data on the code, and
the processor controls the measurement timings or the number of times the imaging unit performs the imaging, by use of the condition information.

6. The observation apparatus according to claim 1, wherein
the code is provided on a fixing plate which is arranged on the transparent plate and fixes a position of the sample, and
the processor determines the position of the sample, based on the image data on the code.

7. The observation apparatus according to claim 1, wherein the processor acquires the image data on the code after the observation apparatus establishes communications with an external apparatus and before the imaging unit acquires image data relating to observation of the sample.

8. The observation apparatus according to claim 7, wherein
the code includes condition information regarding measurement conditions, and
the processor acquires the condition information, based on the image data on the code, and controls the observation apparatus based on the condition information.

9. The observation apparatus according to claim 1, further comprising an illumination unit which illuminates a region to be imaged by the imaging unit,
wherein the illumination unit emits illumination light in synchronism with the imaging performed by the imaging unit.

10. An observation system comprising:
an observation apparatus according to claim 1 and further comprising a communication device provided inside the casing; and
a controller which is provided outside the casing, and which communicates with the observation apparatus via the communication device and controls the observation apparatus.

11. A culture vessel comprising a code from which reference position-specifying information is acquired by imaging.

12. A control method for an observation apparatus comprising a casing including a transparent plate and configured to hold a sample placed on the transparent plate; an imaging unit provided inside the casing; a driving mechanism provided inside the casing and configured to move the imaging unit, the control method comprising:
imaging a code arranged on the transparent plate;
controlling sample imaging, based on image data on the code;
moving the imaging unit; and
generating image data by taking an image through the transparent plate.
